(19) United States
(12) Patent Application Publication
(10) Pub. No.: US 2025/0203283 A1
(43) Pub. Date: Jun. 19, 2025

(54) PROCESSES AND SYSTEMS FOR HEADPHONE TUNING

(71) Applicant: Yellow Matter Entertainment, LLC, Los Angeles, CA (US)

(72) Inventor: Steven Slate Lintz, Los Angeles, CA (US)

(21) Appl. No.: 18/983,324

(22) Filed: Dec. 16, 2024

Related U.S. Application Data
(60) Provisional application No. 63/611,073, filed on Dec. 15, 2023.

(51) Int. Cl. H04R 3/04; G06F 3/16; H04R 1/10; H04R 1/22

(52) U.S. Cl. CPC H04R 3/04; G06F 3/162; H04R 1/1008; H04R 1/22

(57) ABSTRACT

The processes and systems for tuning headphones includes analyzing a baseline audio profile for a lower range reference frequency and a midrange reference frequency, and adjusting an amplitude of the lower range reference frequency to equal that of an amplitude of the midrange reference frequency. A user-interactable interface works in conjunction with the headphones to generate a tone at the adjusted amplitude of the lower range reference frequency and a tone at an initial amplitude of a midrange tuned frequency from a user sound profile so the user can hear the differences in amplitudes. Thereafter, the user modifies the initial amplitude of the midrange tuned frequency within the user sound profile by a discrepancy value based on the difference between the adjusted amplitude of the lower range reference frequency and the initial amplitude of the midrange tuned frequency so the user sound profile better corresponds to the baseline audio profile.

### BACKGROUND

The present invention generally relates to processes and systems for headphone tuning. More specifically, the processes and systems for headphone tuning disclosed herein includes an audio tuning interface that enables a user to alter the sound profile of music played back through headphones to more closely match the auditory perception intended by the manufacturer based on the unique ear anatomy of the user.

Headphones are audio devices designed to be worn over or in the ears to listen to sound from electronic devices like smartphones, computers, music players, or other audio sources. Headphones convert electrical audio signals into sound that the user can hear, typically through small speakers (drivers) positioned near or in the ears. Headphones designed to be worn over the ears usually include a pair of ear cups attached on opposite sides of a strap, the combination of which are designed to keep the headphones securely attached to the user so the ear cups, which usually house the drivers, sit over and around the ears to seal the ears therein from the external environment and associated background noise. Soft padding on the ear cups provides additional comfort, and typically helps with noise isolation.

The speakers (drivers) in the ear cups of the headphones receive audio signals typically in the form of an electrical current that represents sound. When the audio signals (an alternating electrical current) pass through a voice coil in the speaker, it creates a changing magnetic field that interacts with a permanent magnet therein, and the changing magnetic force causes the voice coil to move back and forth. This movement causes a diaphragm coupled to the voice coil to vibrate, and the vibration of the diaphragm pushes and pulls air to create sound waves. These sound waves travel into the ear and are perceived as sound when the waves vibrate the eardrum. The frequency response the user experiences with respect to the vibrations generated by the speaker is based on how the sound waves generated by the speaker interact with the anatomy of the inner ear, including the eardrum. Because the anatomy of the inner ear tends to be different for every person, the perceived amplitude of the sound waves interacting with the inner ear and eardrum also tend to be different, especially for sound waves having midrange frequencies between about 1 kHz to 5 kHz.

For decades, headphone manufacturers have attempted to “tune” the sound of their headphones to provide the most detailed and optimized sound to the user. By using certain components in the electronic and mechanical design, manufacturers have attempted to provide each user with a frequency response that is pleasing. Although, unfortunately, it is not possible for a single headphone design to offer the same frequency response to all users because the perceived amplitude of certain frequencies, especially in the midrange frequencies mentioned above, varies depending on the anatomy of the inner ear. Thus, different users of the same set of headphones can have a different and unique listing experience.

In this respect, the concept of Head Related Transfer Function (“HRTF”) is how a person perceives sound coming from a point in space. HRTF is a complex anatomical function related to how the head and its internal cavities, the torso, shoulders, and/or ear shape, among other anatomical factors, modify sound before it reaches the ear. HRTF is thus unique for each person. For example, the shape of the inner ear canal and the surrounding “pinna” tend to directly affect the amplitude that certain frequencies, in the overall frequency response, are perceived by the ear drum. Anatomical differences in the inner ear and eardrum effectively “customize” the sound profile for all auditory sources for each user, including the perceived frequency response and location of the sound source.

When wearing headphones, the relatively small speakers in the ear cups produce sound directly near the opening of the ear. But, given that unique HRTF is strongly correlated with the inner ear, the auditory perception of a common sound profile will be experienced differently or uniquely by each user. Thus, it is possible for two users wearing the same headphones and listening to the same audio input to have two completely different experiences because each user has a unique frequency response to the audio based on their anatomy.

It is possible to determine how the frequency response differs within the ear of each listener by measuring a frequency response for each user with an ultra-small microphone placed inside the ear canal, and then comparing the measured frequency response for the user to that of a reference frequency response. In this respect, FIG. 1 illustrates a diagram 10 charting a pair of sine sweeps played through a headphone as experienced by two different users having different inner ear profiles. As shown, there is almost no discrepancy between a sine sweep 12 of the first user and a sine sweep 14 of the second user within the 20 hertz (“Hz”) to 800 Hz range and above 7 kilohertz (“kHz”). Accordingly, all users tend to hear frequencies within these ranges at comparable amplitudes regardless of differences in the ear anatomy. In this respect, FIG. 1 also illustrates that the core differences in perceived tonal amplitude between the sine sweep 12 of the first user and the sine sweep 14 of the second user typically exists above 800 Hz and below 7 kHz, with the largest frequency discrepancies most commonly occurring at about 3.5 kHz. In fact, depending on the respective anatomies of two users, midrange frequencies in the 1.5 kHz to 5 kHz range can deviate up to 10 decibels (“db”). Consequently, two users could listen to the same audio input in a headphone, but one user perceives these midrange frequencies to be much louder or softer than another user. This is problematic for the headphone manufacturer because it is impossible for a headphone to produce a sound profile consistently experienced by all users because the frequency response, i.e., how each user perceives the amplitude of frequencies interacting with the eardrum, is different for each user based on variations of the inner ear anatomy.

There exists, therefore, a significant need in the art for processes and systems for headphone tuning, such as by way of adjusting the amplitude of certain frequencies based on comparative testing, so an audio input played through a headphone sounds approximately the same for each user, thereby neutralizing natural anatomical sound discrepancies. The present invention fulfills these needs and provides further related advantages.

### SUMMARY

In one embodiment of a process for tuning a headphone, the steps include analyzing a baseline audio profile for a lower range reference frequency and a midrange reference frequency and adjusting an amplitude of the lower range reference frequency to that of an amplitude of the midrange reference frequency. This sets a benchmark where the user can hear the intended amplitude of the midrange reference frequency without changes due to differences in inner ear anatomy or HRTF.

The next step is to generate a tone at the adjusted amplitude of the lower range reference frequency and a tone at an initial amplitude of a midrange tuned frequency from a user sound profile so the user can hear and compare the differences. Here, the user adjusts the playback of the midrange tuned frequency until the amplitude matches that of the adjusted amplitude of the lower range reference frequency. Thereafter, the initial amplitude of the midrange tuned frequency is modified within the user sound profile by a discrepancy value based on the difference between the adjusted amplitude of the lower range reference frequency and the initial amplitude of the midrange tuned frequency so a modified amplitude of the midrange tuned frequency is closer to the amplitude of the midrange reference frequency than the initial amplitude of the midrange tuned frequency. Making this modification to the user sound profile produces a frequency response experienced by the user that more aligns with the intended audio experience of the manufacturer.

Additionally, the system may tune the baseline audio profile, which may be used to then map a sine sweep of the baseline audio profile, including the amplitude of the lower range reference frequency and the amplitude of the midrange reference frequency. This mapping of the baseline audio profile may then be used to assign the lower range reference frequency multiple adjusted amplitudes each of which correspond to an amplitude of one of multiple other midrange reference frequencies of the baseline audio profile for use to increase the number of data points taken within the midrange frequencies, which enhances the modification of the user sound profile to track the baseline audio profile more closely. In this respect, the modifying step may further include a step of changing multiple initial amplitudes of multiple other midrange tuned frequencies within the user sound profile by a corresponding set of discrepancy values based on a difference between each initial amplitude of the multiple other midrange tuned frequencies and each of the corresponding multiple adjusted amplitudes of the lower range reference frequencies. Here, each of the multiple other midrange tuned frequencies have a frequency the same as each of the multiple other midrange reference frequencies.

Additionally, in another aspect of these embodiments, the system may automatically select the multiple other midrange tuned frequencies, or the system may enable the user to manually select one or more of the other midrange tuned frequencies by way of a user-interactable interface, such as a touch screen or mixing table having a plurality of assignable faders. Here, the system may then blend the set of discrepancy values to create a user-specific Q filter with a relatively higher resolution mapping the user sound profile to the baseline audio profile because of all the additional datapoints correlating the amplitudes of the midrange tuned frequencies to the amplitudes of the midrange reference frequencies the manufacturer of the headphones intended the user to hear when listen to music, etc. In some embodiments, the lower range reference frequency may include frequencies below 800 Hz, and in more specific embodiments, the lower range reference frequency may be a single frequency within a range of 100 Hz to 500 Hz. Additionally, the midrange reference frequency may be between 800 Hz and 7 kHz, and in more specific embodiments, the midrange reference frequency may be a single frequency within a range of 1 kHz to 5 kHz.

In another aspect of these embodiments, the system may extrapolate multiple other discrepancy values assignable to multiple other midrange tuned frequencies based on the discrepancy value set by the user during testing, the baseline audio profile, and the user sound profile. Here, the system may modify these multiple other midrange tuned frequencies with the extrapolated discrepancy values in an effort to better track the audio playback of the user sound profile to that of the baseline audio profile, without requiring the user to manually configure multiple of the midrange tuned frequencies. Here, the extrapolating step may include assigning a new amplitude to each of the multiple other midrange tuned frequencies in the user sound profile based on an average sine sweep. Alternatively, the extrapolating step may include progressively decreasing the multiple other discrepancy values for each of the multiple other midrange tuned frequencies intermittently backwards from 3.5 kHz to 1 kHz and forwards from 3.5 kHz to 6 kHz. In this latter embodiment, the user may attempt to tune a midrange tuned frequency having the largest discrepancy (e.g., 10 db at 3.5 kHz), whereby the system can then generally step down the discrepancy value to help close the amplitude gap between the user sound profile and the baseline audio profile for multiple of the midrange frequencies.

When the user is comparing the amplitudes of the adjusted amplitude of the lower range reference frequency and the initial amplitude of the midrange tuned frequency, the system may pulse the tone of the midrange tuned frequency in between playing the tone of the lower range reference frequency. Alternatively, the generating step may include playing the lower range reference frequency and the midrange tuned frequency simultaneously. The discrepancy value is the difference in amplitude the user hears between the adjusted amplitude of the midrange reference frequency and the initial amplitude of the midrange tuned frequency played back during testing. The midrange tuned frequency may be assigned to a fader that the user can control to change the amplitude of the midrange tuned frequency in real-time to compare the amplitude of the midrange tuned frequency to that of the adjusted amplitude of the lower range reference frequency. The user adjusts the fader until the amplitude of the midrange tuned frequency matches that (i.e., is equal to) the adjusted amplitude of the lower range reference frequency.

Additionally, the modifying step may include extrapolating a modified amplitude of multiple midrange tuned frequencies from the user sound profile along a sine sweep curve based on the discrepancy value. In other embodiments, the system may also change the modified amplitudes of the multiple midrange tuned frequencies in equal increments between 1 kHz and 5 kHz, or may change the modified amplitudes of the multiple midrange tuned frequencies based on other data gathered by users submitting tuning feedback.

In another aspect of the embodiments disclosed herein, an audio tuning system includes a user-interactable interface having a baseline audio profile that includes a lower range reference frequency having an amplitude equal to an amplitude of a midrange reference frequency. A headphone in communication with the user-interactable interface is able to playback the lower range reference frequency, and at least one fader coupled with the user-interactable interface may be user-adjustable to alter an initial amplitude of a midrange tuned frequency to equal the playback amplitude of the lower range reference frequency for storage in connection with a user sound profile associated with the headphone.

In one embodiment, the user-interactable interface may be a graphical user interface accessible by way of a computer, tablet or smartphone, and the fader may be an icon movable within the graphical user interface. Alternatively, the user-interactable interface may be a mixer, and the fader may be a movable knob. In some embodiments, the graphical user interface may be an advanced graphical user interface that includes multiple faders, such as may be associated with a fader controller. Each of the one or more faders may be actuable between a first non-engaged position where no midrange tuned frequency plays back through the headphones and a second engaged position where the midrange tuned frequency plays back through the headphones. The multiple faders may be assigned a midrange frequency between 1 kHz and 5 kHz, wherein the headphones may include a switch actuable to activate one of multiple programmable user sound profiles associated therewith.

In another aspect of the embodiments disclosed herein, another process for tuning a headphone includes changing an amplitude of a lower range reference frequency to equal an amplitude of a midrange reference frequency in a baseline audio profile, generating a tone at the changed amplitude of the lower range reference frequency and a tone at an initial amplitude of a midrange tuned frequency from a user audio profile, and modifying the initial amplitude of the midrange tuned frequency in the user audio profile to equal the changed amplitude of the lower range reference frequency.

Additionally, in these embodiments, the system may tune the baseline audio profile and map a sine sweep to the baseline audio profile so that the system can more easily and automatically assign the lower range reference frequency multiple adjusted amplitudes from the sine sweep, each of which would correspond to an amplitude of one of multiple other midrange reference frequencies of the baseline audio profile. As such, here, the modifying step may include changing multiple initial amplitudes of multiple other midrange tuned frequencies within the user sound profile by a corresponding set of discrepancy values based on a difference between each initial amplitude of the multiple other midrange tuned frequencies and each of the corresponding multiple adjusted amplitudes of the lower range reference frequencies. Furthermore, the system may also blend the set of discrepancy values to create a user-specific Q filter with a relatively higher resolution mapping the user sound profile to the baseline audio profile. In these embodiments, each of the multiple other midrange reference frequencies may have a frequency the same as multiple other midrange tuned frequencies, and the lower range reference frequency may be a single frequency within a range of 100 Hz to 500 Hz, while the midrange reference frequency may be a single frequency within a range of 1 kHz to 5 kHz. To tune the midrange tuned frequency, the system may play the lower range reference frequency and the midrange tuned frequency intermittently.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagram illustrating the discrepancy in frequency response of a sine sweep played through a common headphone as experienced by two different listeners;

FIG. 2 is a flowchart illustrating a process for headphone tuning using a single midrange frequency, as disclosed herein;

FIG. 3 is a flowchart similar to FIG. 2, illustrating tuning and blending multiple midrange frequencies;

FIG. 4 illustrates a graphical user interface for tuning one midrange reference frequency with a single fader;

FIG. 5 illustrates an advanced graphical user interface in the form of an audio mixer for tuning multiple midrange frequencies with a series of faders; and

FIG. 6 illustrates a graphical user interface featuring music, for testing and fine tuning headphones to one or more music genres.

### DETAILED DESCRIPTION OF THE PREFERRED EMBODIMENTS

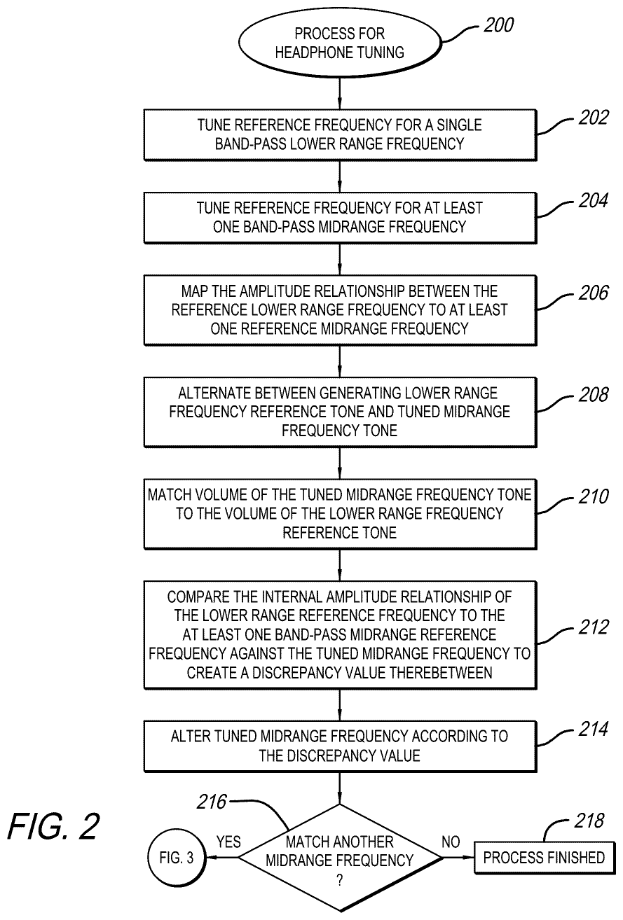

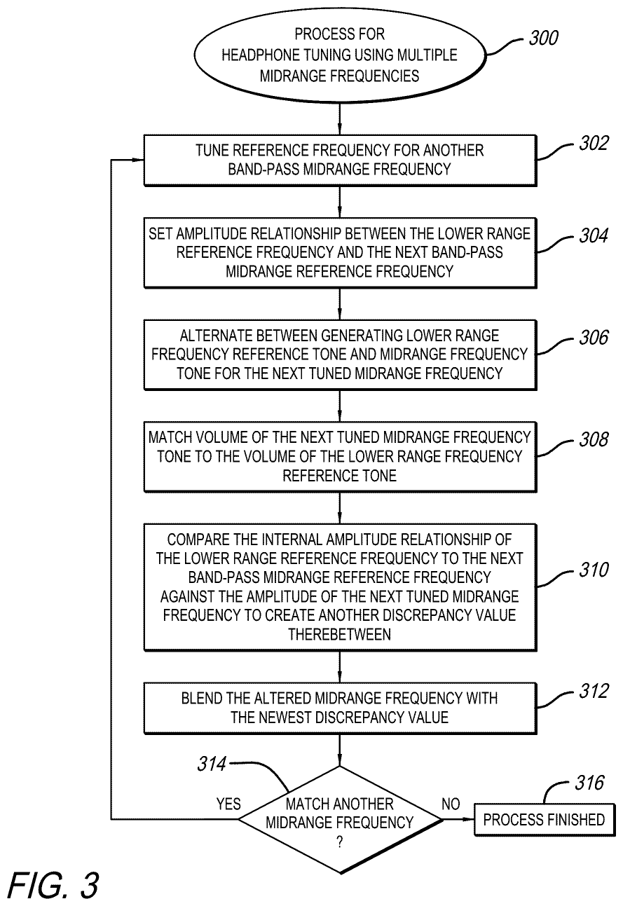

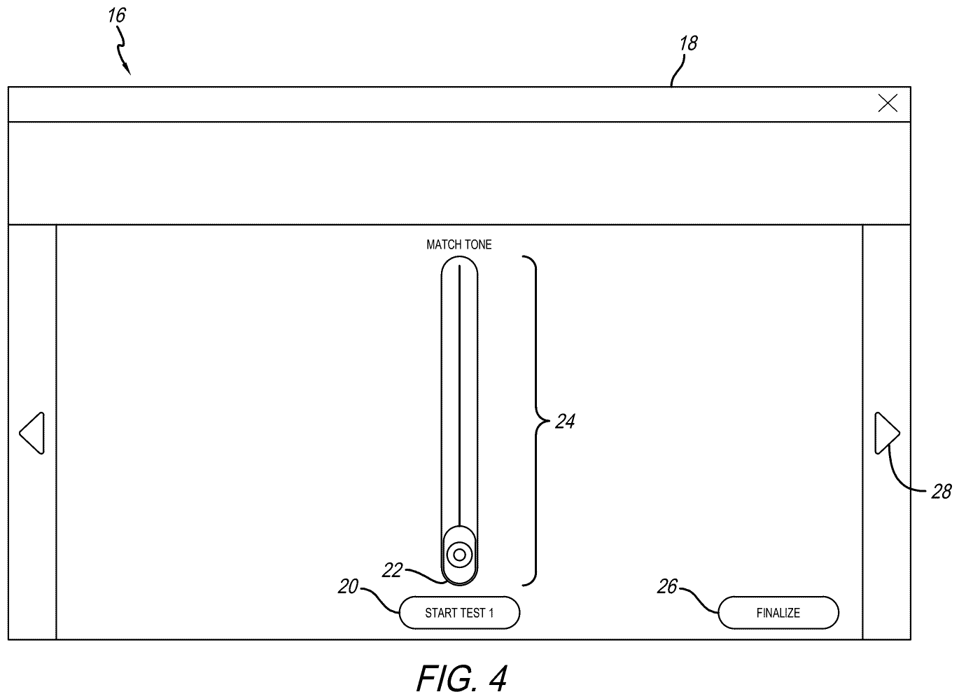

As shown in the exemplary drawings for purposes of illustration, a pair of processes (200) and (300) for headphone tuning are generally illustrated with respect to the flowcharts of FIGS. 2 and 3, and the related systems for carrying out those processes (200) and (300) are illustrated with respect to reference numeral 16 in FIGS. 4-6. Generally, the processes (200) and (300) carried out by the system 16 are designed to enable an audio listener to customize the sound profile played through the speakers of a headphone based on individual, unique auditory perception. Doing so enhances the listening experience for each user as the spatial audio playback through the headphones has a binaural illusion that is more convincing and realistic because the frequency response experienced by the user is specifically tuned to how the headphone manufacturer intended the sound to be heard. Ensuring that all users have approximately the same frequency response from the same set of headphones, regardless of differences in inner ear anatomy or HRTF, enhances the auditory experience for the user of the headphones.

Generally, the system 16 is an interactive custom sound test that enables a user to calibrate headphones so the amplitude of certain frequencies within a sound profile can be more consistently experienced from user to user. The system 16 maps out differences in the amplitudes of certain midrange frequencies against the amplitudes of a baseline sound profile within certain low range frequencies (e.g., published by the manufacturer), and then alters the differing amplitudes the user actually experiences in the tuned midrange frequencies based on feedback from the user during testing/tuning. Modifying the sound profile of audio input played back through the headphones by adjusting the amplitude of midrange frequencies to reduce discrepancies a listener experiences relative to a baseline sound profile published by the manufacturer helps create a more consistent audio experience for the user by accounting for differences in user ear anatomy and HRTF. As such, the system 16 and the related processes (200) and (300) disclosed herein are designed to facilitate tuning the headphones to a desired frequency response that better matches that of the intended amplitudes the manufacturer wants the user to experience when listening to audio.

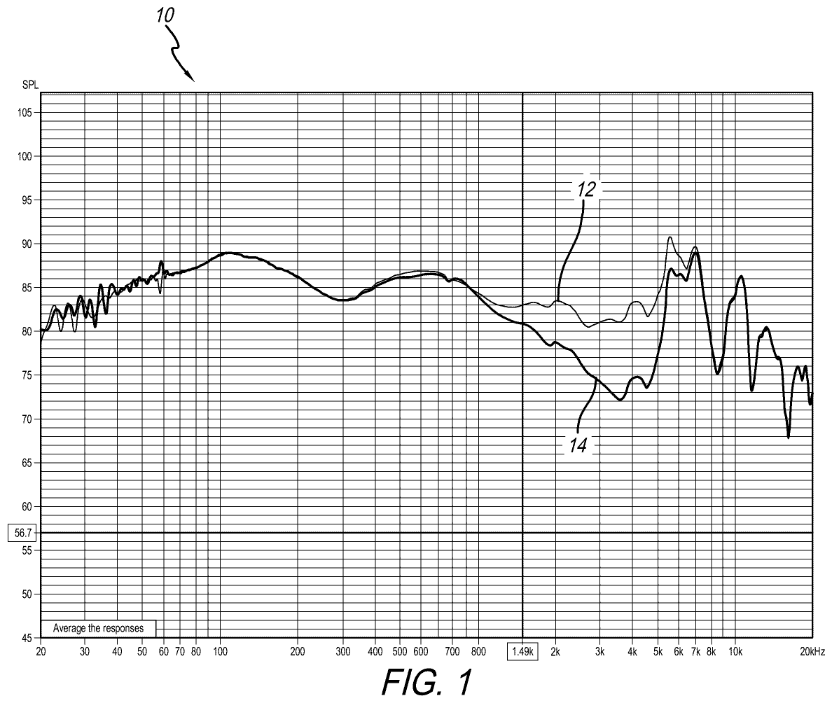

The process (200) starts by tuning a reference frequency for a single band-pass lower range frequency as part of a step (202). The system 16 can consistently map the amplitudes for reference tones within lower frequency ranges because they tend to be common among all users/listeners regardless of differences in anatomy or HRTF. This is illustrated, e.g., in FIG. 1 with respect to fact that the frequency response for the first listener mapped as the first sine sweep 12 overlaps with the frequency response for the second listener mapped as the second sine sweep 14 within frequency ranges below about 800 Hz, even though the first and second listeners have different inner ear anatomies and/or other HRTF considerations. In fact, FIG. 1 is representative of the fact that the average response to sound frequencies between 100 Hz and 500 Hz is almost exactly the same for all users, regardless of the fact that each user may have a different ear anatomy and HRTF. Because all users or listeners tend to perceive sound in headphones at similar amplitudes within the lower frequency range of 100 Hz to 500 Hz, the filter shape within this lower frequency range, e.g., as illustrated in FIG. 1, is typically consistent for all users.

As such, one or more lower range reference frequencies produced by the headphone within this filter shape can be tuned to a specific amplitude and used as one or more baseline reference point(s) for determining adjustments to the input audio within midrange frequencies, where users typically experience differences in frequency amplitudes, as discussed in more detail below. While one reference point is needed for this comparison, using multiple reference points as additional baseline reference points may provide more datapoints to more accurately adjust the amplitude of midrange frequencies during the tuning processes (200) and (300) disclosed herein, as may be uniquely experienced by each individual user.

Once at least one reference frequency for a single band-pass lower range frequency has been tuned and selected as part of step (202), the next step (204) is for the system 16 to tune a reference frequency for at least one band-pass midrange frequency, which is typically considered to be in the range of 1 kHz to 5 kHz where the deviation in amplitude tends to vary the most from one listener to another, as briefly mentioned above. Mapping at least one of these midrange frequencies is used by the system 16 as a metric to determine variations in amplitudes on a listener-by-listener basis to develop a discrepancy value that can be extrapolated within the midrange frequencies to make adjustments to the input audio so that the frequency response experienced by the user better matches a baseline sound profile recommended by the manufacturer. This relationship can be accomplished in step (206) by mapping out the sine sweep of a baseline sound profile, and then correlating the reference frequency from the lower range with a reference frequency somewhere in the midrange.

In using the sine sweep 12 in FIG. 1 as an example of a sine sweep of a baseline sound profile (e.g., recommended by a manufacturer), the amplitude of the 100 Hz frequency is approximately 89 db while the amplitude the user should hear (e.g., as may be recommended by the manufacturer for peak performance) at the 1.49 kHz midrange frequency should be approximately 83 db. As such, the system 16 can map the amplitude of the 100 Hz frequency to 83 db so it matches the amplitude of the frequency the user is expected to hear at 1.49 kHz. In other words, the volume of the 100 Hz frequency can be adjusted to 83 db so it matches the volume of the frequency the user should perceive at 1.49 kHz. Users will consistently hear the 100 Hz frequency tone at 83 db regardless of ear anatomy.

For the purposes of process (200), it is only necessary for the system 16 to select one lower range frequency (e.g., in this example, the amplitude at 100 Hz) and one midrange frequency (e.g., 1.49 kHz) for comparison purposes, but multiple midrange frequencies could be selected for comparison to the lower range reference frequency to achieve a higher matching resolution of the sound profile alterations, as will be discussed in detail herein. In other words, tuning the lower range reference frequency to more midrange frequencies will help the system 16 better match the actual frequency response experienced by the user to the frequency response recommended by the manufacturer because the amplitude discrepancies the user experiences within the selected midrange frequency range (e.g., 1 kHz to 5 kHz) is not necessarily linear, e.g., as illustrated in FIG. 1. In an example where the first sine sweep is the baseline frequency response recommended by the manufacturer, the system 16 will ideally make incremental adjustments to the amplitudes illustrated with respect to the second sine sweep 14 so the practical frequency response experienced by the user/listener actually matches the first sine sweep 12. So, the more frequencies within the midrange that are mapped and tuned, the higher the resolution of adjusting the input audio represented by the second sine sweep 14 to track the first sine sweep 12.

Once the initial mapping of the baseline sound profile is accomplished in step (206), the user is ready to interact with the system 16. In this respect, FIG. 4 illustrates one embodiment of the system 16 in the form of a user-interactable graphical user interface 18, such as a classic audio mixer, which may be accessed by way of a tablet, smartphone, desktop or laptop computer, or other comparable electronic devices known in the art, which may connect to the system 16 by a wireline connection or wirelessly, or otherwise sync with the headphones in a manner capable of transmitting audio therewith. Of course, the user-interactable graphical user interface 18 could also be in the form of a traditional mixer having physical audio controls. In any of these embodiments, the user is able to interact with the graphical user interface 18 to activate the tone of the reference frequency in the lower frequency range at an amplitude (i.e., decibel level) desired at the tuned midrange frequency.

In application, in one embodiment, the system 16 may alternate between playing a tone of the lower range reference frequency having an amplitude adjusted to match that of the amplitude of the recommended midrange frequency being tuned, and the actual midrange frequency being tuned. Doing so enables the user/listener to hear differences in the volume (amplitude) of the two isolated tones as they alternate during playback. This enables the user/listener to then match the amplitude of the selected midrange frequency to that of the tone of the lower range reference frequency as part of a step (210). Alternatively, the system 16 may playback the tuned midrange frequency in the inner ear as a constant tone, while pulsing tones of the lower range reference frequency, and vice versa, to facilitate amplitude matching.

More specifically as illustrated in FIG. 4, this alternating step (208) may be initiated by selecting a start test button 20 within the graphical user interface 18. This may activate transmission of the tone of the lower range reference frequency and the tone of the midrange frequency to be tuned to the speakers in the headphones, in accordance with the embodiments disclosed herein. For example, quickly pulsing the selected lower range reference frequency during tuning may help excite the auditory system of the user in a way that makes the amplitude of the signal easier to perceive when compared to the midrange frequency being tuned.

Thereafter, the step (210) of matching the volume of the tone of the midrange frequency to the volume of the tone of the lower range reference frequency is facilitated by selecting and holding a volume slider or fader 22, which is designed to change the amplitude of the tone of the selected midrange frequency being tuned in the headphones. Here, the fader 22 can move vertically along a slider 24 to alter the volume or amplitude of the tone of the midrange frequency. In this embodiment, moving the fader 22 upwardly along the slider 24 increases the amplitude of the frequency within the headphones (i.e., increases the volume of the midrange frequency tone), while moving the fader 22 downwardly along the slider 24 decreases the amplitude of the frequency (i.e., decreases the volume of the midrange frequency tone). Although, the amplitude can be adjusted using other digital or physical knobs or faders as known in the art. When the user stops moving the fader 22, and while still depressing the fader 22, the midrange frequency reference tone plays through the headphones. The midrange frequency reference tone may automatically alternate with the lower range reference frequency, or the user may need to manually alternate between the two frequencies by tapping the fader 22.

As such, the user is able to hear both the tone of the lower range reference frequency and the tone of the midrange frequency in alternating sequence for purposes of adjusting the fader 22 along the slider 24 to eventually arrive at a condition where the amplitude of the tone of the midrange frequency matches the amplitude of the tone of the lower range reference frequency. In the example mentioned above, the user would move the fader 22 along the slider 24 until the amplitude of the frequency response of the midrange frequency being tuned is perceived by the user tuning the system 16 to be approximately equal to that of the amplitude of the lower range reference frequency altered to tune the midrange frequency (e.g., 83 db in the example mentioned above). Once the user determines that the amplitude of the tone of the midrange frequency matches that of the amplitude of the tone of the lower range reference frequency according to the volumes heard by the user through the headphones, the user releases the slider 22 to lock the value in place.

In another embodiment, the tone of the lower range reference frequency may pulse at predetermined intervals when the fader 22 is not actively selected by the user, and turn off when the fader 22 is actively selected by the user. In this embodiment, because the frequency zones between the tone of the lower range reference frequency and the tone of the midrange frequency being tuned are spectrally distant, pulsing constant playback can make it easier for the user to match the amplitude of the tone of the lower range reference frequency to that of the amplitude of the tone of the midrange frequency being tuned. This may enable the user to more quickly match the perceived amplitude of the midrange frequency playing in the headphones to that of the amplitude of the tone of the lower range reference frequency for purposes of completing the matching step (210).

Once the match has been identified by the user in step (210), and the fader 22 has been released, the system 16 processes the differences in amplitudes to create a discrepancy value therebetween as part of a step (212). Here, the discrepancy value is calculated by taking the difference of the internal amplitude relationship of the lower range reference frequency to the at least one band-pass midrange frequency against the tested midrange frequency.

In the example mentioned above, the system 16 determined that the internal amplitude relationship of the lower range reference frequency to the at least one band-pass midrange frequency was 83 db. The discrepancy value is thus the difference between the amplitude of the first sine sweep 12 (i.e., manufacturer recommended amplitude of 83 db, which should be heard by the user at 1.49 kHz) and the second sine sweep 14 (i.e., the amplitude of 81 db actually perceived by the user tuning the headphones at 1.49 kHz). Here, the difference between the desired 83 db amplitude and the 81 db amplitude perceived by the frequency response of the user is 2 db. While the discrepancy value in this example is 2 db, the discrepancy value could be upwards of ±10 db, or more, depending on the manufacturer recommended values and anatomy of the user.

This discrepancy value is then used by an equalizer processor as part of a step (214) to alter the midrange frequency along the sine sweep curve to better replicate the intended sound within the headphones for that particular user or listener sound profile. In one embodiment, the alteration may be based on a single value through a predetermined frequency range (e.g., 1 kHz to 5 kHz). In the example mentioned above where the discrepancy value of the midrange frequency being tuned is 2 db, this would include altering the amplitude for all frequencies between 1 kHz and 5 kHz upward by 2 db using a custom Q filter. Doing so draws the frequency response embodied by the second sine sweep 14 into closer approximation with the first sine sweep 12 intended for the user listening experience. As such, once the equalizer process finishes, the headphones will have a unique filter preset customized for a particular user, which is designed to produce a frequency response unique for that user so the audio perception better matches the audio perception recommended by manufacturer.

Alternatively, the equalizer processor may not alter the midrange frequency along the sine sweep curve linearly. In this respect, the equalizer processor may determine that the discrepancy value needs to vary depending on the midrange frequency. For example, the equalizer processor may change the amplitude for certain frequencies by more or less decibels than the discrepancy value. For example, if the discrepancy value between the first sine sweep 12 and the second sine sweep 14 is approximately 10 db at 3.5 kHz, the equalizer processor may progressively decrease the discrepancy value from 3.5 kHz to 1 kHz and from 3.5 kHz to 6 kHz. The equalizer processor may automatically make these changes based on average discrepancies from user feedback or other known preconditions. Such changes may be linear progressions between certain frequency iterations, or the changes in the discrepancy value from one frequency to another may be based on other data, such as average or mean alterations for feedback data collected from users over time. Again, the goal here is to modify the second sine sweep 14 so it maps as closely as possible to the first sine sweep 12.

For example, with respect to FIG. 1, such extrapolation may include increasing the amplitudes for certain frequencies for the second user defining the second sine sweep 14 by between 1 db (e.g., in the range of about 1 kHz to 1.5 kHz) and 8 db (e.g., in the range of about 3 kHz and 5 kHz). Alternatively, if the reference frequency is represented in FIG. 1 by the second sine sweep 14, then the system 16 would adjust the audio output by decreasing certain frequencies defined by the first sine sweep 12 by between 1 db (e.g., in the range of about 1 kHz to 1.5 kHz) and 8 db (e.g., in the range of about 3 kHz and 5 kHz) to better match the first sine sweep 12 to the second sine sweep 14. In this respect, the equalizer processor in the system 16 uses the discrepancy value to change the speaker output in the headphones so the user hears audio more consistent with the maximum intended amplitude for certain frequencies recommended by the manufacturer.

Once the user successfully matches the frequencies and the equalizer process concludes, the user must then determine whether to match another midrange frequency as part of step (216), if the option is provided. For basic users, the option may not be provided because the process (200) may suffice so the user can match one midrange frequency tone to the single lower range reference frequency. As such, if the user determines that there is no need to match an additional midrange frequency, or is not given the option in the graphical user interface 18, the user may select a finalize button 26 (FIG. 4) and the process finishes as part of step (218). At this point, the system 16 has programmed a unique filter preset (e.g., a relatively wide Q curve with a center point, e.g., of around 3.5 kHz when this frequency is selected as the midrange frequency to tune) for the headphones customized to the user who provided feedback data from the test as part of the process (200). The filter preset uses specifically tuned filters at the midrange frequencies and the preset filter shape is different than the test frequency filter shapes. This new filter preset customizes the audio spectrum for each ear so the audio perception for that specific user now more closely matches the audio perception as intended by the manufacturer.

In one embodiment, the headphones may be programmable to be used with multiple users. As such, more than one user could complete the process (200) and/or the process (300) discussed in more detail below, and save their unique tuning data in connection with a profile associated with the headphones. The headphones may include a selector (e.g., a switch or button) that allows a user to select their profile so the headphones apply that user's filter preset previously tuned for use with the headphones. The profile may also be controlled with a software application, such as an app on a smartphone.

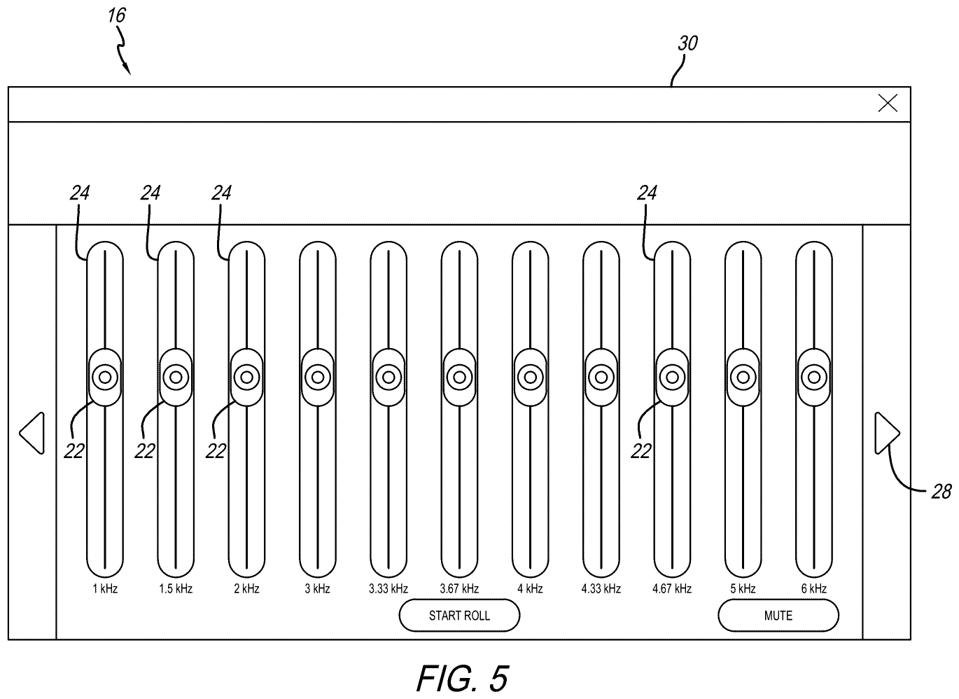

Alternatively, the user may decide as part of step (216), when given the option, to match additional midrange frequencies and move to a more advanced process (300), which would enhance the resolution and accuracy related to tuning the filter preset for each particular user within the midrange frequencies. In one example, more advanced audio listeners may have the option to tune three midrange frequencies. Here, the resulting equalizer processor may compile a preset filter that contains three filters using a slimmer Q curve. This provides a more detailed result because the tuning is now based on three unique frequency zones, e.g., within the 1.5 to 5 kHz range. In another example, advanced audio listeners may have the option to tune up to eleven midrange frequency tones. This provides an extremely customized listening experience for the user because the system 16 tunes fine portions of the midrange frequency response. In this embodiment, as illustrated below with respect to one example in FIG. 5, the resulting equalizer curve may have many relatively thin frequency zones, e.g., in the 1.5 kHz to 5 kHz range.

As such, in general, providing further data points to alter the midrange frequencies helps the system 16 better match the expected user experience intended by the manufacturer. For example, as illustrated in FIG. 4, the user may start the process (300) by selecting a next or forward button 28. The user may next have the option of manually selecting one or more additional frequencies to tune as part of the process (300). In this embodiment, the user may be able to select additional frequencies one-by-one to tune the headphones on a frequency-by-frequency basis. Accordingly, after selecting another band-pass midrange frequency to tune as part of step (302), the system 16 next sets the amplitude relationship between the prior selected lower range reference frequency and the next band-pass midrange frequency as part of step (304), similar to that disclosed above with respect to step (206).

Here, the user may again be presented with the graphical user interface 18, except this time the fader 22 changes the amplitude of the next band-pass midrange frequency being tested. Similar to the embodiments discussed above with respect to step (208), the system 16 may alternate between generating the lower range reference frequency tone and the midrange frequency tone for the next midrange frequency as part of a step (306). This enables the user to hear the differences between the tone of the lower range reference frequency and the tone of the currently selected midrange frequency, and the user can move the fader 22 along the slider 24 to change the amplitude of the testing midrange frequency to match the lower range reference frequency tone as part of a step (308), in a similar manner as disclosed above with respect to step (210). The next step (310) is for the system 16 to compare the internal amplitude relationship of the lower range reference frequency to the next band-pass midrange frequency against the amplitude of the tested next midrange frequency to create another discrepancy value therebetween. Doing so creates another data point the system 16 can use to further alter the sine sweep to better match the frequency response of the intended user experience of the headphones. In this respect, the system 16 blends the previously altered midrange frequency performed as part of step (214) with the new midrange frequency discrepancy value for the next tested midrange frequency, to create a more accurate sine sweep designed to replicate the user audio experience intended by the headphone manufacturer, as part of a step (312). The equalizer processor may perform similar steps with respect to step (312) as disclosed above with respect to step (214), albeit the equalizer processor can rely on more accurate field-compiled datapoints unique to a particular user, as opposed to compiled data or algorithms that may not track the specific user's frequency response as specifically.

Next, the user may, again, be presented with an option for deciding whether to match another midrange frequency as part of a step (314) or finish the process as part of step (316). If the user decides to match another midrange frequency, the process (300) effectively starts again in step (302) by selecting another band-pass midrange frequency to tune, and then repeating steps (304) to (310) based on that next selected midrange frequency. This time, the blending step (312) would be performed using three discrepancy values once step (310) has been completed again. Using a higher resolution of datapoints enables the equalizer processor to create a more accurate alteration of the input audio to match manufacturer specifications. The process (300) continues to repeat to create new (additional) data points for blending in step (312) to create a sine sweep that more closely represents the auditory experience intended by the headphone manufacturer, and based specifically on the anatomy of the specific individual user conducting the tuning. The user may finish the process in a step (316) by selecting the finalize button 26 illustrated in FIG. 4 when finished.

Alternatively, in a more advanced mode, the system 16 may present the user with an advanced graphical user interface 30, such as the one illustrated in FIG. 5. Here, as shown, the advanced graphical user interface 30 may include multiple of the faders 22, each of which correspond to a different midrange frequency the user is able to tune. For instance, FIG. 5 illustrates that the advanced graphical user interface 30 includes eleven of the faders 22. In this respect, each of the faders 22 may represent a single midrange frequency somewhere in the range of 1-5 kHz. Although, of course, the number of the faders 22 shown in the advanced graphical user interface 30 may be as few as two, or as many as the advanced graphical user interface 30 can reasonably display (e.g., traditional large mixers can have over one hundred faders). In this respect, the frequencies assigned to each of the faders 22 may be spaced apart evenly within the 1-5 kHz range (e.g., at 1.00 kHz, 1.33 kHz, 1.67 kHz, 2.00 kHz, etc.), or the frequencies assigned to each of the faders 22 may be intermittent based on an estimate where the largest discrepancies exist between the perceived frequency response of the user and the ideal sine sweep intended by the manufacturer for any particular set of headphones. For example, in using FIG. 1 as an example, the user may be given an option to tune more frequencies within the range of about 3 kHz to 5 kHz, as these are the frequency ranges with the largest discrepancy values. Although, not all of the faders 22 may be programmed within this range. Rather, the faders 22 may programmed at 1 kHz, 1.5 kHz, 2 kHz, 3 kHz, and then spaced apart at shorter intervals between 3 kHz and 5 kHz, such as at 3.33 kHz, 3.67 kHz, 4 kHz, 4.33 kHz, 4.67 kHz, and 5 kHz, and then the last fader 22 may be programmed to tune frequencies at 6 kHz. Here, the user may be able to more specifically tune a finer range of midrange frequencies within a range having larger discrepancies, and tune fewer frequency ranges where the discrepancies are anticipated to be smaller.

The system 16 may automatically assign the frequencies needing tuning to each of the faders 22, the user may manually assign the frequencies needing tuning to each of the faders 22, or the system 16 and the advanced graphical user interface 30 may be designed to automatically assign some frequencies while allowing the user to manually assign others. In the latter embodiment, the advanced graphical user interface 30 may present the user with one or more preset frequencies that can be tuned, along with an option where the user may select one or more custom frequencies to tune to be assigned the faders 22. This feature allows for more customization, especially for advanced users and audiophiles, including that the system 16 may enable the user to select the number of faders 22 to be used for tuning. This embodiment is particularly customizable when the advanced graphical user interface 30 is electronically displayed on a screen, such as a touch-sensitive tablet or smartphone.

The blending step (312), of course, takes into consideration each of the tuned frequencies and their corresponding discrepancy values after the user completes tuning using the multiple faders 22 illustrated in FIG. 5. In this embodiment, the blending step (312) may occur simultaneously for all tuned frequencies illustrated, e.g., in FIG. 5. Using multiple of the faders 22 better enhances calibration of the sine sweep because it generates more data points for the equalizer processor to use in altering the sine sweep to better match that of the one published by the manufacturer for any particular set of headphones.

To perform the matching step (308) for the embodiment illustrated in FIG. 5, the user may simply select and hold any one of the faders 22 for tuning to activate producing the lower range reference frequency at the target amplitude (volume) in alternating sequence with producing the applicable midrange frequency being tuned. In other words, selecting and holding any one of the faders 22 will isolate playback to that particular band-passed midrange frequency for tuning. Moving the fader 22 along the applicable slider 24 changes the amplitude (volume) of the applicable midrange frequency being tuned. Once the user determines that the amplitudes are comparable, e.g., as part of step (308), the user releases the fader 22 to lock the discrepancy value in place for processing. Of course, the discrepancy values for each midrange frequency assigned per each of the faders 22 may be different. The equalizer processor will then blend the altered midrange frequency based on the discrepancy values saved for each midrange frequency tuned, e.g., by the user selecting the forward button 28 illustrated in FIG. 5.

In one feature of these embodiments, the amplitude relationship of the reference frequency tone to that of the selected midrange frequency tone may be initially smart tuned to estimate the desired frequency response the manufacturer intends the user to experience. After tuning the various amplitude relationships of the tuned frequencies, all users, regardless of their personal HRTF, should experience the same audio playback when listening to audio from the headphones.

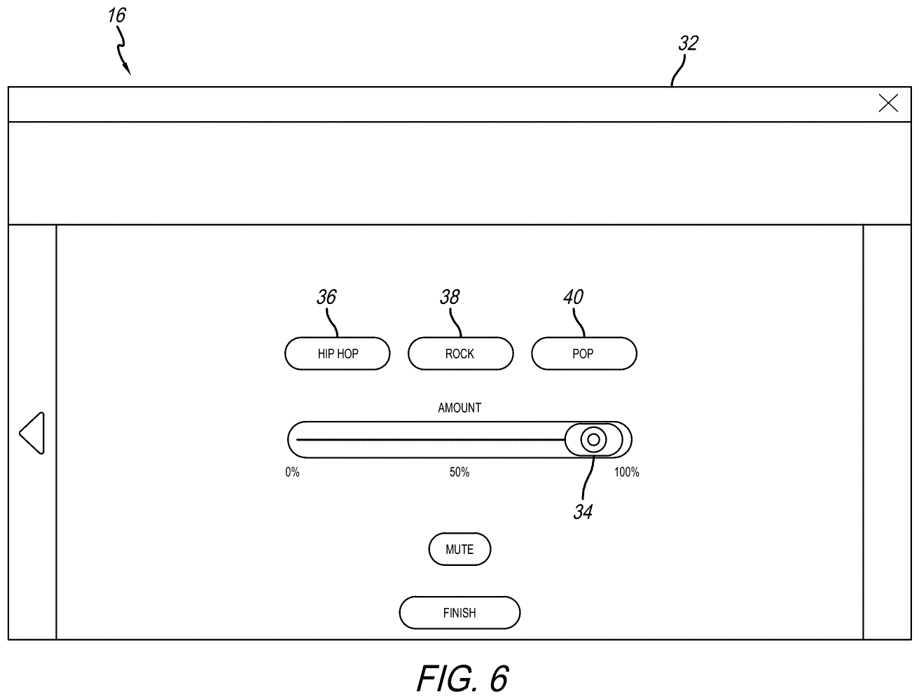

In another example, FIG. 6 illustrates an embodiment wherein the system 16 is in the form of a graphical user interface featuring music 32 where the user can listen to musical examples using the new equalizer preset (based on the values from the aforementioned tuning), to further fine tune the overall amplitude of the values using a percentage slider 34. Here, the user may select from pre-set music genres such as from a hip hop button 36, a rock button 38, and/or a pop button 40. Although, of course, the graphical user interface featuring music 32 may include more for less of the buttons 36, 38, 40 and/or may include other genres, like country, classical, or oldies music for testing purposes. Here, locating the slider 34 at 100% tracks the value of the tuned sine sweep exactly, while moving the slider 34 to an amount below 100% decreases the overall amplitude (volume).

There are several options to customize the user experience. For example, users can select the pulse speed of the reference tones (e.g., the lower range reference frequency tone and/or the midrange frequency being tuned), the overall output volume, and can use both mouse and keyboard simultaneously to solo the midrange frequencies and instantly change fader values to control amplitude. A user can also perform the processes (200) and/or (300) discretely on each ear, since it is common that a user will have different spectral discrepancies (e.g., due to differences in inner ear anatomy and different HRTF) for each ear.

Although several embodiments have been described in detail for purposes of illustration, various modifications may be made without departing from the scope and spirit of the invention. Accordingly, the invention is not to be limited, except as by the appended claims.

What is claimed is:

1. A process for tuning a headphone, comprising the steps of:
analyzing a baseline audio profile for a lower range reference frequency and a midrange reference frequency;
adjusting an amplitude of the lower range reference frequency to that of an amplitude of the midrange reference frequency;
generating a tone at the adjusted amplitude of the lower range reference frequency and a tone at an initial amplitude of a midrange tuned frequency from a user sound profile; and
modifying the initial amplitude of the midrange tuned frequency within the user sound profile by a discrepancy value between the adjusted amplitude of the lower range reference frequency and the initial amplitude of the midrange tuned frequency so a modified amplitude of the midrange tuned frequency is closer to the amplitude of the midrange reference frequency than the initial amplitude of the midrange tuned frequency.

2. The process of claim 1, including the step of tuning the baseline audio profile.

3. The process of claim 2, including the step of mapping a sine sweep of the baseline audio profile, including the amplitude of the lower range reference frequency and the amplitude of the midrange reference frequency.

4. The process of claim 1, including the step of assigning the lower range reference frequency multiple adjusted amplitudes each of which correspond to an amplitude of one of multiple other midrange reference frequencies of the baseline audio profile.

5. The process of claim 4, wherein the modifying step includes the step of changing multiple initial amplitudes of multiple other midrange tuned frequencies within the user sound profile by a corresponding set of discrepancy values based on a difference between each initial amplitude of the multiple other midrange tuned frequencies and each of the corresponding multiple adjusted amplitudes of the lower range reference frequencies.

6. The process of claim 5, wherein each of the multiple other midrange tuned frequencies have a frequency the same as each of the multiple other midrange reference frequencies.

7. The process of claim 5, including the step of automatically selecting the multiple other midrange tuned frequencies.

8. The process of claim 5, including the step of blending the set of discrepancy values to create a user-specific Q filter with a relatively higher resolution mapping the user sound profile to the baseline audio profile.

9. The process of claim 1, wherein the lower range reference frequency comprises a single frequency within a range of 100 Hz to 500 Hz.

10. The process of claim 1, wherein the midrange reference frequency comprises a single frequency within a range of 1 kHz to 5 kHz.

11. The process of claim 1, including the step of extrapolating multiple other discrepancy values based on the discrepancy value, the baseline audio profile, and the user sound profile, and modifying multiple other midrange tuned frequencies with the extrapolated discrepancy values.

12. The process of claim 11, wherein the extrapolating step includes assigning a new amplitude to each of the multiple other midrange tuned frequencies in the user sound profile based on an average sine sweep.

13. The process of claim 11, including the step of progressively decreasing the multiple other discrepancy values for each of the multiple other midrange tuned frequencies intermittently from 3.5 kHz to 1 kHz and from 3.5 kHz to 6 kHz.

14. The process of claim 1, including the step of pulsing the tone of the midrange tuned frequency.

15. The process of claim 1, wherein the generating step includes the step of playing the lower range reference frequency and the midrange tuned frequency simultaneously.

16. The process of claim 1, wherein the discrepancy value comprises a difference between the adjusted amplitude of the midrange reference frequency and the initial amplitude of the midrange tuned frequency.

17. The process of claim 1, wherein the modifying step includes the step of extrapolating a modified amplitude of multiple midrange tuned frequencies from the user sound profile along a sine sweep curve based on the discrepancy value.

18. The process of claim 17, including the step of changing the modified amplitudes of the multiple midrange tuned frequencies in equal increments between 1 kHz and 5 kHz.

19. The process of claim 1, including the step of assigning the midrange tuned frequency to a fader.

20. An audio tuning system, comprising:
a user-interactable interface having a baseline audio profile that includes a lower range reference frequency having an amplitude equal to an amplitude of a midrange reference frequency;
a headphone in communication with the user-interactable interface to playback the lower range reference frequency; and
at least one fader coupled with the user-interactable interface and user-adjustable to alter an initial amplitude of a midrange tuned frequency to equal the playback amplitude of the lower range reference frequency for storage in connection with a user sound profile associated with the headphone.

21. The system of claim 20, wherein the user-interactable interface comprises a graphical user interface.

22. The system of claim 21, wherein the fader comprises an icon on the graphical user interface or knob.

23. The system of claim 20, wherein the fader is actuable between a first non-engaged position where no midrange tuned frequency plays back through the headphones and a second engaged position where the midrange tuned frequency plays back through the headphones.

24. The system of claim 20, wherein the headphones include a switch actuable to activate one of multiple programmable user sound profiles associated therewith.

25. The system of claim 20, wherein the graphical user interface comprises an advanced graphical user interface including multiple of the faders.

26. The system of claim 25, wherein the advanced graphical user interface comprises a fader controller.

27. The system of claim 25, wherein each of the multiple faders is assigned a frequency between 1 kHz and 5 kHz.

28. A process for tuning a headphone, comprising the steps of:
changing an amplitude of a lower range reference frequency to equal an amplitude of a midrange reference frequency in a baseline audio profile;
generating a tone at the changed amplitude of the lower range reference frequency and a tone at an initial amplitude of a midrange tuned frequency from a user audio profile; and
modifying the initial amplitude of the midrange tuned frequency in the user audio profile to equal the changed amplitude of the lower range reference frequency.

29. The process of claim 28, including the steps of tuning the baseline audio profile and mapping a sine sweep to the baseline audio profile.

30. The process of claim 29, including the step of assigning the lower range reference frequency multiple adjusted amplitudes from the sine sweep, each of which correspond to an amplitude of one of multiple other midrange reference frequencies of the baseline audio profile.

31. The process of claim 30, wherein the modifying step includes the step of changing multiple initial amplitudes of multiple other midrange tuned frequencies within the user sound profile by a corresponding set of discrepancy values based on a difference between each initial amplitude of the multiple other midrange tuned frequencies and each of the corresponding multiple adjusted amplitudes of the lower range reference frequencies.

32. The process of claim 31, including the step of blending the set of discrepancy values to create a user-specific Q filter with a relatively higher resolution mapping the user sound profile to the baseline audio profile.

33. The process of claim 30, wherein each of the multiple other midrange reference frequencies have a frequency the same as multiple other midrange tuned frequencies.

34. The process of claim 28, wherein the lower range reference frequency comprises a single frequency within a range of 100 Hz to 500 Hz and the midrange reference frequency comprises a single frequency within a range of 1 kHz to 5 kHz.

35. The process of claim 28, including the step of playing the lower range reference frequency and the midrange tuned frequency intermittently.
